(19) United States
(12) Patent Application Publication
(10) Pub. No.: US 2005/0125890 A1
(43) Pub. Date: Jun. 16, 2005

(54) Multi-purpose hand shower

(76) Inventors: Sam Zhadanov, Brooklyn, NY (US); Eli Zhadanov, Brooklyn, NY (US)

Correspondence Address: Ilya Zborovsky, 6 Schoolhouse Way, Dix Hills, NY, 11746, US

(21) Appl. No.: 10/733,833

(22) Filed: Dec. 12, 2003

(51) Int. Cl. A47K 1/00

(52) U.S. Cl. 4/615

(57) ABSTRACT

A multi-purpose hand shower which has a handle connectable with a source of water, a showerhead attached to the handle and formed so that water can pass through the showerhead onto a person when the person holds the handle, and an additional scrubbing element which is operative for applying to a person's body a scrubbing action which is different from a washing action of water, the additional scrubbing element being attached to the showerhead, so that when a person holds the handle in one hand, simultaneously the showerhead is held and the additional scrubbing element is held in one hand, and a person can therefore provide a flow of water from the showerhead onto a person's body and also an additional scrubbing action by the additional scrubbing element to the person's body.

### BACKGROUND OF THE INVENTION

The present invention relates to hand showers.

Hand showers are known and widely used for showering. A known hand shower includes a showerhead which is mounted on a handle, so that a person who uses a hand shower can hold the handle and direct a flow of water through the showerhead onto corresponding parts of his body. When it is necessary in addition to provide corresponding scrubbing actions to be applied on a body, additional scrubbing elements are used separately, such as sponges, brushes, etc. This creates inconvenience since a person must hold the hand shower in one hand and hold the additional scrubbing element in the other hand. It is believed to be advisable to provide a hand shower which eliminates the above mentioned disadvantages of the prior art.

### SUMMARY OF THE INVENTION

Accordingly, it is an object of the present invention to provide a hand shower which is a further improvement of the existing hand showers.

In keeping with these objects and with others which will become apparent hereinafter, one feature of the present resides, briefly stated, in a hand shower which has a handle connectable with a source of water; a showerhead attached to said handle and formed so that water can pass through said showerhead onto a person when the person holds said handle, and an additional scrubbing element which is operative for applying on to person's body a scrubbing action which is different from a washing action of water, said additional scrubbing element being attached to said showerhead and formed so that when a person holds said handle in one hand, simultaneously said showerhead is held and said additional scrubbing element is held in one hand, and a person can therefore provide a flow of water from said showerhead onto a person's body and also an additional action by said additional scrubbing element to the person's body.

When the hand shower is designed in accordance with the present invention, a user by holding the handle of the hand shower in one hand can direct a flow of water through the showerhead onto the user's body, and at the same time, when needed, the user attaches the additional scrubbing element to the showerhead and can provide an additional scrubbing action to the user's body, while the water issued from the showerhead can flow through the additional scrubbing element, providing a rinsing action, or can flow directly onto the user's body. Thus, the hand shower of the of the invention becomes a multi-purpose hand shower, in which only the showerhead can be used, or the additional scrubbing element can be used, or both.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a known hand shower;

FIG. 2 is a view showing an additional scrubbing element attachable to the showerhead of the multi-purpose hand shower;

FIG. 3 is a view showing a connecting element for connecting the additional scrubbing element to the showerhead of the multi-purpose hand shower;

FIG. 4 is a view showing the connecting element in accordance with another embodiment;

FIG. 5 is a view showing the assembled multi-purpose hand shower in accordance with the present invention, including the handle, the showerhead, and the additional scrubbing element connected by the connecting element to the showerhead;

FIG. 6 is an end view of the additional scrubbing element shown in FIG. 3;

FIGS. 7a-7d are views showing the additional scrubbing element formed as a brush element;

FIGS. 8a-8d are views showing the additional scrubbing element formed as a ring-shaped element with spikes; and

FIG. 9 is a view showing an additional scrubbing element formed as a pumice or a grinding stone.

### DESCRIPTION OF THE PREFERRED EMBODIMENTS

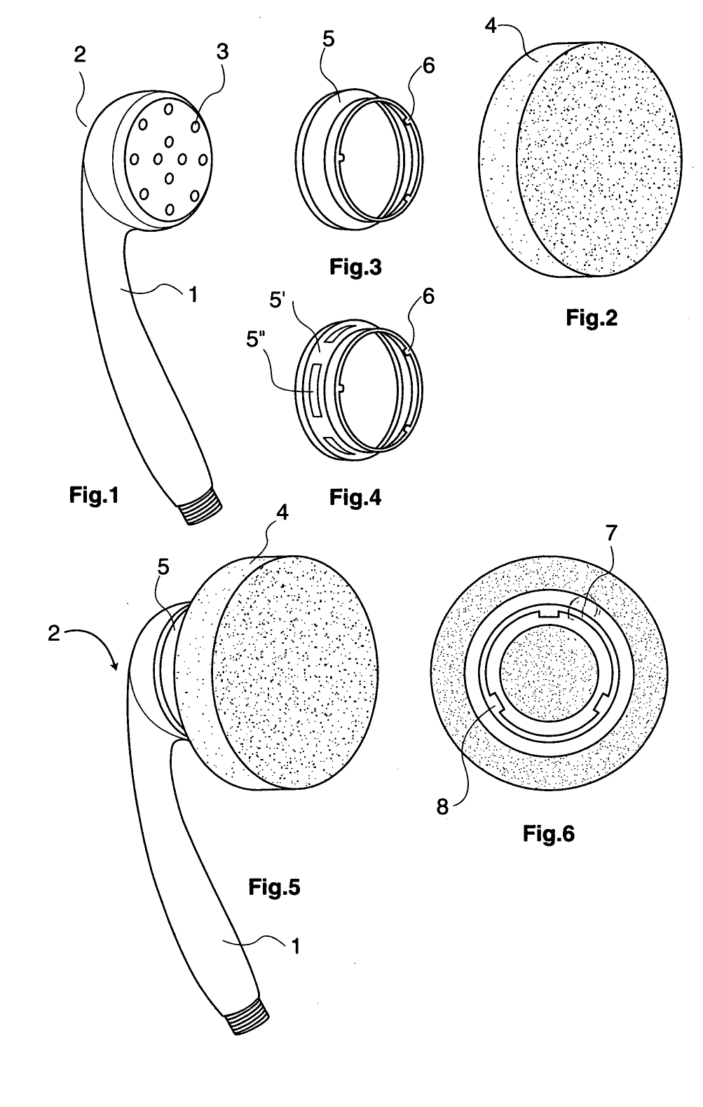

A multi-purpose hand shower in accordance with the present invention has a handle which is identified with reference numeral 1, and a showerhead 2 which is attached to the handle 1 and provided with a plurality of openings 3 as shown in FIG. 1. The constructions of the handle 1 and the showerhead 2 can be different and they are not germane for the present invention. The handle 1 is hollow and connectable to a source of running water.

In accordance with the present invention, the hand shower is provided with an additional scrubbing element which is identified with reference numeral 4 in FIG. 2. In the embodiment shown in FIG. 2 the additional scrubbing element is formed for example as a porous element, such as a sponge, a fiber pad and the like. The additional scrubbing element 4 is removably attachable to the showerhead 2 of the hand shower. In particular, one of the possible ways to attach the additional scrubbing element 4 to the showerhead is to provide a connecting element 5 shown in FIG. 3.

The connecting element 5 is ring-shaped. It can be attached to the showerhead 2 by simply snapping on a circular peripheral surface of the showerhead 2. In addition, the connecting element 5 is provided with bent projections 6. On the other hand, the additional scrubbing element 4 has a holding member 7 which is attached to its side surface by glueing or welding and has a plurality of undercut slots 8, as shown in FIG. 6. The additional scrubbing element 4 can be attached to the connecting element 5 by introducing the projections 6 into the slots 8 of the holding member 7 and turning the additional scrubbing element 4 and the connecting element 5 relative to one another around the axis, so as to provide a bayonet connection. Then, the connecting element 5 together with the additional scrubbing element 4 can be snapped onto the showerhead 2.

In operation the user holds the handle 1 of the hand shower with one hand, and water flows through the showerhead 2 onto a user's body. Simultaneously, the user can provide an additional action on his body by the additional scrubbing element 4 which is attached to the showerhead 2. The water which issues from the showerhead 2 passes through the pores of the porous additional scrubbing element 4 and onto the user's body, while the material of the additional scrubbing element 4 provides a corresponding rubbing, scratching and other action. Therefore, it is not necessary to have two separate devices, namely a hand shower with the handle and the showerhead on one hand, and an additional rubbing, or scratching element on the other hand, and to manipulate them with two user's hands to operate them separately.

FIG. 4 shows a connecting element 5′ which is substantially similar to the connecting element 5 of FIG. 3, but has throughgoing openings 5″ on its portion. As a result, water flowing through the showerhead 2 can flow out through the openings 5″ onto the user's body. In this case, the additional scrubbing element can be formed not permeable for water, so that water does not flow through it.

In another embodiment the connecting element 5′ is provided with the openings 5″, and the additional scrubbing element is nevertheless water permeable. In this construction one part of water flows through the openings 5″ directly onto the user's body, while another part of water flows through the additional scrubbing element to provide a desired distribution of water for washing action and for scrubbing action.

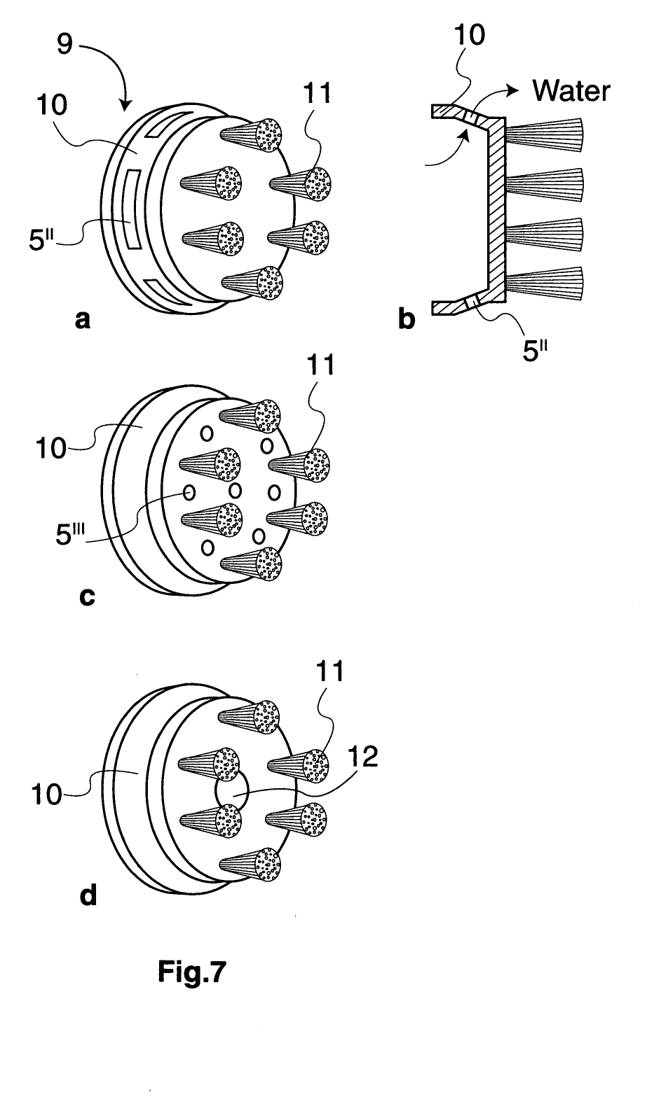

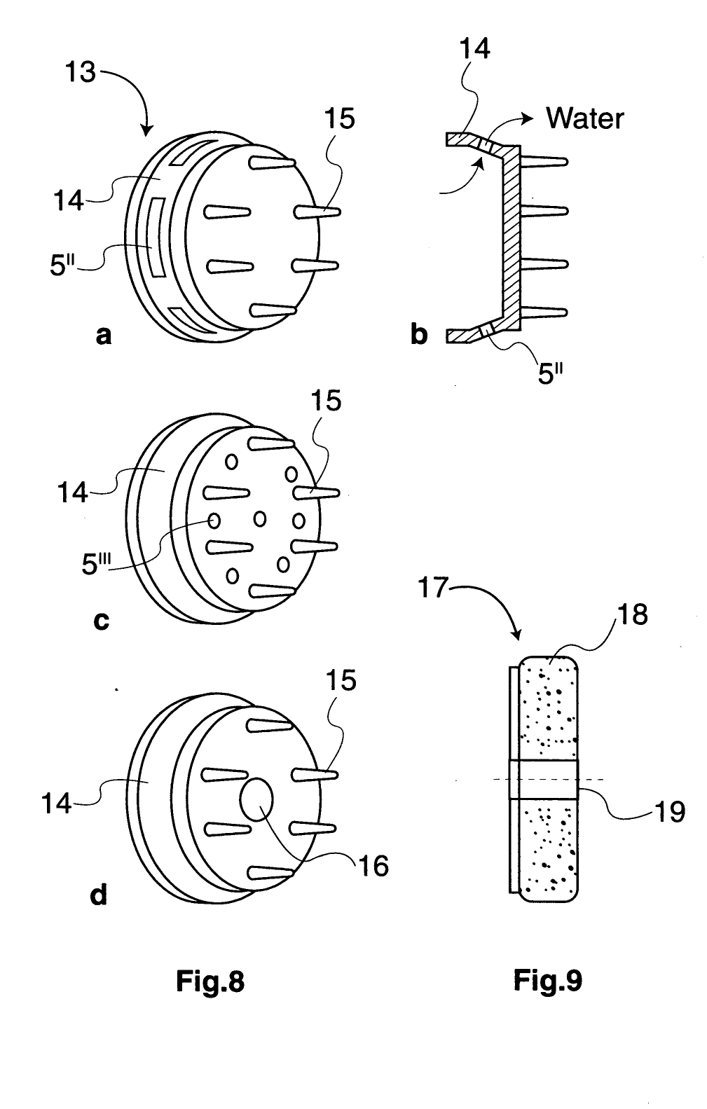

FIGS. 7a-7d show an additional scrubbing element which is identified as a whole with reference numeral 9 and is formed as a brush. It has a body 10 and a plurality of bristles 11 extending from the body 10. The body 10 can be provided with the side openings 5″ (FIGS. 7a, 7b) with a plurality of axes-parallel throughgoing openings 5′″ (FIG. 7c) or with a central opening 12 (FIG. 8d). When the additional scrubbing element 9 is attached to the showerhead 2, for example by snap-on, and water issues from the showerhead 2, it passes through the openings 5″, 5′″ or 12 of the additional scrubbing element 9, and at the same time the user can use the additional scrubbing element 9, in particular its bristles 11 for applying a corresponding action to the user's body.

Another additional scrubbing element 13 is shown in FIGS. 8a-8d. It has a body 14 which is formed for example as a plastic ring and provided with a plurality of spikes 15. The body 14 can be provided with the side openings 5″ (FIGS. 8a, 8b), with a plurality of axes-parallel throughgoing openings 5′″ (FIG. 8c) or with a central opening 16 (FIG. 8d). When the additional scrubbing element 13 is attached to the showerhead 2, for example by snap-on, and a user holds the handle, water flows through the showerhead 2 and through the openings 5″, 5′″ or 16 of the additional scrubbing element 13 onto a user's body, at the same time the user can apply an additional scrubbing action to his body by the spikes 15.

FIG. 9 shows an additional scrubbing element 17 formed as pumice or a grinding stone. It has a body 18 composed of a corresponding material and provided with a central throughgoing opening 19. The operation is substantially the same. In particular when the additional scrubbing element 17 is attached to the showerhead 2, for example by snap-on, and the user holds the handle 1, water issues from the showerhead 2 and passes through the central opening 19 of the additional scrubbing element 17 to flow onto the user's body and at the same time the body 18 of the additional scrubbing element 17 can be used for corresponding cleaning, scrubbing and other actions on the body.

It is believed to be clear that in accordance with the present invention, in an advantageous and unobvious manner, it is possible, by holding the handle of the hand shower in one hand to apply an action of water flowing from the showerhead and also to apply an additional scrubbing action by the additional scrubbing element which is attached to the showerhead.

It will be understood that each of the elements described above, or two or more together, may also find a useful application in other types of constructions differing from the types described above.

While the invention has been illustrated and described as embodied in a hand shower, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A multi-purpose hand shower which has a handle connectable with a source of water; a showerhead attached to said handle and formed so that water can pass through said showerhead onto a person when the person holds said handle, and an additional scrubbing element which is operative for applying to a person's body a scrubbing action which is different from a washing action of water, said additional scrubbing element being attached to said showerhead, so that when a person holds said handle in one hand, simultaneously said showerhead is held and said additional scrubbing element is held in one hand, and a person can therefore provide a flow of water from said showerhead onto a person's body and also an additional scrubbing action by said additional scrubbing element to the person's body.

2. A multi-purpose hand shower as defined in claim 1, wherein said additional scrubbing element is directly attachable to said showerhead.

3. A multi-purpose hand shower as defined in claim 1, wherein said additional scrubbing element is snappable onto an outer surface of said showerhead.

4. A multi-purpose hand shower as defined in claim 1; and further comprising a connecting element for attaching said additional scrubbing element to said showerhead.

5. A multi-purpose hand shower as defined in claim 4, wherein said connecting element and said additional scrubbing element have connecting means cooperating with one another to attach said additional scrubbing element to said connecting element.

6. A multi-purpose hand shower as defined in claim 5, wherein said connecting element is snappable onto said showerhead.

7. A multi-purpose hand shower as defined in claim 6, wherein said additional scrubbing element has a holding member which is fixedly attached to said additional scrubbing element and is removably connectable with said connecting element.

8. A multi-purpose hand shower as defined in claim 1, wherein said showerhead and said additional scrubbing element are formed so that water flows from said showerhead onto a user's body and does not flow through said additional scrubbing element.

9. A multi-purpose hand shower as defined in claim 8, wherein said additional scrubbing element is formed as a brush having a body attachable to said showerhead and a plurality of bristles arranged on said body.

10. A multi-purpose hand shower as defined in claim 8, wherein said additional scrubbing element has a body attachable to said showerhead and provided with a plurality of elongated spikes.

11. A multi-purpose hand shower as defined in claim 8, wherein said additional scrubbing element is formed as an element selected from the group consisting of a pumice and a grinding stone attachable to said showerhead.

12. A multi-purpose hand shower as defined in claim 1, wherein said showerhead and said additional scrubbing element are formed so that water flows from said showerhead onto a user's body through said additional scrubbing element.

13. A multi-purpose hand shower as defined in claim 12, wherein said additional scrubbing element is formed as a brush having a body attachable to said showerhead and a plurality of bristles arranged on said body.

14. A multi-purpose hand shower as defined in claim 12, wherein said additional scrubbing element has a body attachable to said showerhead and provided with a plurality of elongated spikes.

15. A multi-purpose hand shower as defined in claim 12, wherein said additional scrubbing element is formed as an element selected from the group consisting of a pumice and a grinding stone attachable to said showerhead.

16. A multi-purpose hand shower as defined in claim 12, wherein said additional scrubbing element is an element selected from the group consisting of a porous sponge and porous fiber pad.

17. A multi-purpose hand shower as defined in claim 12, wherein said additional scrubbing element is porous so as to allow water to flow through its pores onto the person.

18. A multi-purpose hand shower as defined in claim 1, wherein said showerhead and said additional scrubbing element are formed so that one part of water flowing from said showerhead flows onto a user's body outside said additional scrubbing element while another part of water flowing from said showerhead flows through said additional scrubbing element.

19. A multi-purpose hand shower as defined in claim 18, wherein said additional scrubbing element is formed as a brush having a body attachable to said showerhead and a plurality of bristles arranged on said body.

20. A multi-purpose hand shower as defined in claim 18, wherein said additional scrubbing element has a body attachable to said showerhead and provided with a plurality of elongated spikes.

21. A multi-purpose hand shower as defined in claim 18, wherein said additional scrubbing element is porous.

22. A multi-purpose hand shower as defined in claim 1, and further comprising a connecting element which connects said additional scrubbing element with said showerhead and is provided with at least one opening through which water flows from said showerhead directly onto the user's body outside said additional scrubbing element.

23. A multi-purpose hand shower as defined in claim 22, wherein said additional scrubbing element is porous and arranged so that water also flows through said porous additional scrubbing element.
